(19) United States
(12) Patent Application Publication
(10) Pub. No.: US 2024/0015471 A1
(43) Pub. Date: Jan. 11, 2024

(54) GEO-FENCE SERVICE DISCOVERY

(71) Applicant: PROTOCOL TECHNOLOGIES, INC., ATLANTA, GA (US)

(72) Inventor: PACE DAVIS, ATLANTA, GA (US)

(73) Assignee: PROTOCOL TECHNOLOGIES, INC., ATLANTA, GA (US)

(21) Appl. No.: 18/348,951

(22) Filed: Jul. 7, 2023

Related U.S. Application Data
(60) Provisional application No. 63/368,044, filed on Jul. 8, 2022.

(51) Int. Cl. H04W 4/021; H04W 48/14; H04L 67/51

(52) U.S. Cl. CPC H04W 4/021; H04W 48/14; H04L 67/51

(57) ABSTRACT

Methods, systems, devices, processes and others for geo-fence service discovery including a device with a geo-fence detection engine and a services detection engine; wherein the geo-fence detection engine identifies the device entering a geo-fenced location; and wherein the services detection engine administers services through requests and responses between the services detection engine of the device and the services administration module administering the geo-fenced location services provided while the device is withing the geo-fenced location.

### BACKGROUND

A geo-fence is a geographic boundary, defined by GPS or RFID or other technology, that enables software to trigger a response when a mobile device or other device enters or leaves a particular area. Service discovery is the process of automatically detecting devices and services on a network. Service discovery protocol (SDP), for example, is a networking standard that accomplishes detection of networks by identifying resources.

Traditionally, service discovery helps reduce configuration efforts by users who are presented with compatible resources, such as a Bluetooth-enabled printer or server. It would be advantageous to have a system, method, and product to be able to discover services in a geo-fence.

### BRIEF DESCRIPTION OF THE DRAWINGS

FIG. 1 sets forth a system diagram illustrating an example networked system for geo-service discovery according to embodiments of the present invention.

### DETAILED DESCRIPTION

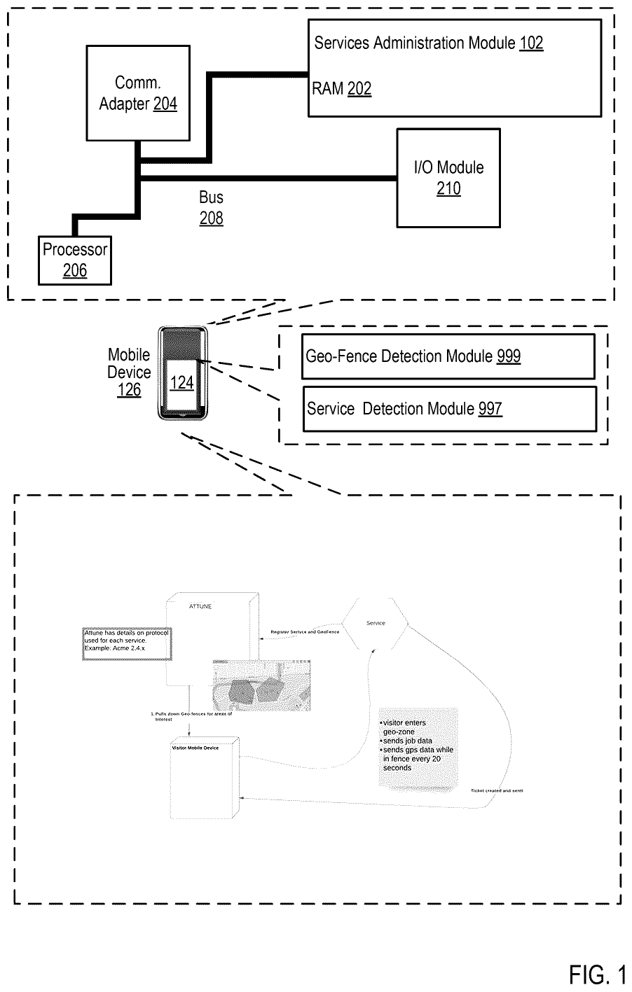

Example embodiments of the present invention are described with reference to the accompanying drawings, beginning with FIG. 1. FIG. 1 sets forth a system diagram illustrating a system of geo-fence service discovery according to embodiments of the present invention.

The system of FIG. 1 is a service that acts as a registry where geo-fences are stored and refer to REST service endpoints you can connect to. You receive one or more URL endpoints that include meta-data describing protocol and version. Information is then shared with and obtained from each service while the truck is within the geo-fence.

While REST APIs are described, they are described for explanation and not for limitation. In fact, many protocols, APIs, and software and hardware may be used to carry out geo-service discovery according to embodiments of the present invention.

In some embodiments, users are assigned key pairs (public and private keys) and their public keys are stored in the registry. Messages sent from visitor to service provider are signed by the visitor's private key and encrypted with the service provider's public key. This allows service providers to authenticate the data provider and also assures to the data provider that only the intended recipient can view the data.

Services are Restful interfaces. Attune is only involved in geo-targeted service location, not in the transmission of data between the visitor and the service provider. Data is transmitted directly (i.e. peer-to-peer) between the visitors and the services. It is not a centralized service.

The Attune service supports a validator role. The validator is responsible for validating that geo-fences registered are actually owned by that site/location and does this by signing geo-fence/site records it validates.

Pickup Site Example:

A truck who's driver has a mobile hauler app loaded with all geo-fences in the region it services drives into a quarry and geo-fence entry is triggered. According to the protocol and version of the service associated with the geo-fence, the mobile app sends job details to a restful service and provides GPS coordinates every X seconds while on site. In return, the hauler app receives the digital ticket when loaded.

Drop off Site Example:

Truck drives into a drop-off geo-fence, and the hauler app triggers entry. It then sends its current ticket data, and provides GPS coordinates every X seconds while on site. The contractor may send specific drop-off instructions back to the app. Finally, the app sends notification of delivery and the contractor app sends an e-signature/signoff event back to the truck app. Each party can have a different vendor solution.

Modifications, additions, or omissions may be made to the various embodiments described herein without departing from the scope of the disclosure.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

What is claimed is:

1. A system for geo-fence service discovery, the system comprising:
a device with a geo-fence detection engine and a services detection engine;
wherein the geo-fence detection engine identifies the device entering a geo-fenced location; and wherein the services detection engine administers services through requests and responses between the services detection engine of the device and the services administration module administering the geo-fenced location services provided while the device is withing the geo-fenced location.
